(19) United States
(12) Patent Application Publication
(10) Pub. No.: US 2013/0343969 A1
(43) Pub. Date: Dec. 26, 2013

(54) Particulate Materials for Uranium Extraction and Related Processes

(71) Applicant: Massachusetts Institute of Technology, Cambridge, MA (US)

(72) Inventors: Lev E. Bromberg, Swampscott, MA (US); Yaroslav Klichko, Brighton, MA (US); T. Alan Hatton, Sudbury, MA (US)

(21) Appl. No.: 13/922,314

(22) Filed: Jun. 20, 2013

Related U.S. Application Data
(60) Provisional application No. 61/662,566, filed on Jun. 21, 2012.

(51) Int. Cl. B01J 20/28; C22B 59/00; C22B 60/02

(52) U.S. Cl. CPC B01J 20/28009; C22B 60/0265; C22B 59/00
USPC 423/7; 423/1; 423/21.5; 252/62.54

(57) ABSTRACT

Extraction method for recovering metals. Phosphoric acid is contacted with an extractant suspension of solid particulate material comprising a para- or ferromagnetic material core surrounded by an outer shell of a chelating polymer whereby a metal is the solution is adsorbed on the chelating polymer, thereby removing it from the phosphoric acid solution. The metal-containing solid particulate material is magnetically separated from the solution and the metal is stripped from the solid particulate material for reuse.

This application claims priority to provisional application Ser. No. 61/662,566 filed on Jun. 21, 2012, the contents of which are incorporated herein by reference.

### BACKGROUND OF THE INVENTION

This invention relates to a method for recovering substantially all of dissolved metals such as uranium and rare earth metal values from raffinate obtained as a by-product in the production of phosphoric acid by the mineral acid decomposition of phosphate materials.

It is known to make phosphoric acid by the mineral acid decomposition of phosphate minerals. Such processes that use phosphated minerals that are decomposed with an acid are known in the art as “wet processes” and they are the only economic alternative way to produce phosphoric acid and related fertilizers. These wet processes depend on a mineral acid that is used for the acidulation. The acid may be nitric, hydrochloric, or sulfuric acid. As a result, the raffinates obtained by dissolution of phosphate minerals are very acidic in nature. It is desirable to be able to remove uranium and rare earth metals from the phosphoric acid solution.

Extractants that are useful in removing uranium and rare earth metals, including lanthanides and actinides from very acidic raffinates and waste streams are known in the art. See, W. W. Schulz and L. D. McIssac, “Bidentate Organophosphorus Extractants: Purification, Properties and Applications to Removal of Actinides from Acidic Waste Solutions,” Atlantic Richfield Hanford Company report ARH-SA-263 (May 1977); R. R. Shoun, W. J. McDowell, and B. Weaver, “Bidentate Organophosphorus Compounds as Extractants from Acidic Waste Solutions: A Comparative and Systematic Study,” in Proc. Int. Solvent Extraction Conf., Canadian Institute of Mining and Metallurgy, Special Vol. 21, Proc. Int. Solvent Extraction Conf. (1977), pp. 101-107.

In particular, tri-n-butylphosphate (TBP), di-(2-ethylhexyl) phosphoric acid (D2EHPA), trioctylphosphine (TOPO), dihexyl-N,N-diethylcarbamoylmethylphosphonate (DHDECMP), octylthenol-N,N-diisobutylcarbomoylmethylphosphine oxide (CMPO), sodium bis (2-ethylhexyl) sulfosuccinate and the like are selective extractants suitable for removing uranium, actinide and lanthanide elements from acid solutions. See, U.S. Pat. No. 5,395,532. All of these extractants are soluble in acid-immiscible hydrocarbons and are therefore employed in the metal removal from acidic raffinates and other aqueous solutions by liquid-liquid extraction processes known in the prior art and exemplified in FIG. 1. However, liquid-liquid solvent extraction-based uranium recovery processes are disadvantageous because of the necessity of the utilization of costly capital equipment for solvent recovery.

The solvent recovery problem has been addressed in the prior art by a process for the separation of uranium and other related metals which consists in selectively sorbing uranium values on a solid support. Processes known in the art include solid supports such as styrenedivinylbenzene beads, a polyurethane foam, porous glass beads, and the like, loaded with a solid solvent extractant such as a trioctylphosphine oxide (TOPO), octylphenyl-N,N-diisobutylcarbamoylmethylphosphine oxide and the like. See, U.S. Pat. No. 4,683,124 to Muscatello. After sorption to recover uranium or other metals, for instance in a column operated in the manner of an ion-exchange column, the loaded sorption material is removed from the column and is either incinerated or acid digested to recover the metals. Conventional solvents may also be used to strip extractant and actinides from the support. However, in such systems, wherein solid supports are physically loaded and not chemically bound to the selective extractants, the support/extractant materials are not reusable and thus are not cost-effective.

Solid polymeric supports that are chemically bound to selective uranium extractants are known in the art and comprise Merrifield chloromethylated resin grafted with CMPO and other like extractants. See, Ch. S. Kesava Raju, M. S. Subramanian, “Sequential separation of lanthanides, thorium and uranium using novel solid phase extraction method from high acidic nuclear wastes,” J. Hazard. Mater. 2007, 145, 315-322. Such grafted resin can be re-used by sequential sorption of metal values from acidic solutions and stripping the metal off the solid support by ammonium carbonate and similar salts. However, chromatography-like column-based processes are not cost-effective to large scale processes such as processing of acidic raffinate solutions to generate large waste streams under reuse conditions.

It is an object of the present invention to provide a continuous liquid-solid extraction system that provides efficiency and cost-saving advantages with respect to the prior art liquid-liquid solvent extraction-based uranium recovery processes.

### SUMMARY OF THE INVENTION

In a first aspect, the invention is an extraction method for removing metals from a phosphoric acid solution that includes contacting the phosphoric acid solution with an extractant suspension of solid particulate material comprising a para- or ferromagnetic material core surrounded by an outer shell of a chelating polymer whereby a metal in the solution is adsorbed on the chelating polymer thereby removing it from the phosphoric acid solution. The metal-containing solid particulate material is magnetically separated from the solution and the metal is stripped from the solid particulate material in a magnetic separation column. In a preferred embodiment the metal is uranium. Other metals that may be recovered are rare earth metals, including lanthanides and actinides. A preferred embodiment further includes using a stripping solution to produce an alkali form of the metal. The stripping solution is then treated to neutralize the alkali to produce an acidic metal solution. The acidic metal solution is reacted with hydrogen peroxide to precipitate a metal peroxide salt. Finally, the metal peroxide salt is thickened, washed, dried and calcined to produce the metal. Suitable outer shell of chelating polymers includes CMPO and TOPO.

In another aspect, the invention is an extractant particle comprising a para- or ferromagnetic material core surrounded by an outer shell of a chelating polymer. In a preferred embodiment, the core material is chromium dioxide, cobalt or amine-stabilized cobalt. Suitable chelating polymer is CMPO or TOPO. It is preferred that the material core particle size be in the range of 20-500 nm. A suitable saturation magnetization is approximately 60 to 120 emu/gram. In a preferred embodiment, the outer shell comprises a protective polymer that is further modified by an extractant. The protective polymer shields the magnetic core from dissolution in the acidic aqueous solution containing uranium. Suitable protective polymers include chloromethylated polystyrene, chloromethylated polystyrene crosslinked with divinylbenzene (Merrifield resin), poly(styrene-alt-maleic anhydride), poly(methylmethacrylate), linear siloxane polymers [—SiRR′O—] (with various alkyl and aryl R and R′ side groups), sesquisiloxane polymers, siloxane-silarylene polymers [—Si(CH₃)₂OSi(CH₃)₂(C₆H₄)m-] (where the phenylenes are either meta or para), silalkylene polymers [—Si(CH₃)₂(CH₂)m-], polysiloxanes, random and block copolymers, and blends of some of the above. Suitable extractants include TOPO, CMPO and bis(diphenylphosphinal) methane (BDPPM) as well as synergistic mixtures thereof as known in the art.

The present invention offers several cost-saving advantages over prior art techniques. First of all, a hydrocarbon carrier such as a kerosene carrier in the TOPO-D2EHPA process is eliminated. Fewer process steps and simpler processes within steps are utilized, resulting in fewer equipment items. The present invention results in higher overall uranium recoveries and lower capital and operating costs.

### BRIEF DESCRIPTION OF THE DRAWING

FIG. 1 is a chemical diagram illustrating a prior art liquid-liquid uranium extraction process using di-(2-ethylhexyl) phosphoric acid and trioctylphosphine extractants.

FIG. 2 is a chemical schematic of CMPO grafting on a particle shell composed of chloromethylated styrene.

FIG. 3 is a transmission electron microscopy micrograph showing Magtrieve encapsulated into a polymer matrix on the left and the same latex after modification with CMPO on the right.

FIG. 4 is a graph of weight change percent versus temperature for a thermogravimetric analysis.

FIG. 5 is a graph of absorbance against wave number showing the spectrum of magnetic particles encapsulated in PCMS and modified with CMPO.

FIG. 6 are graphs of magnetic moment versus field for unencapsulated Magtrieve and for encapsulated Magtrieve.

FIG. 7 is a graph of mass of uranium adsorbed per mass of adsorbent.

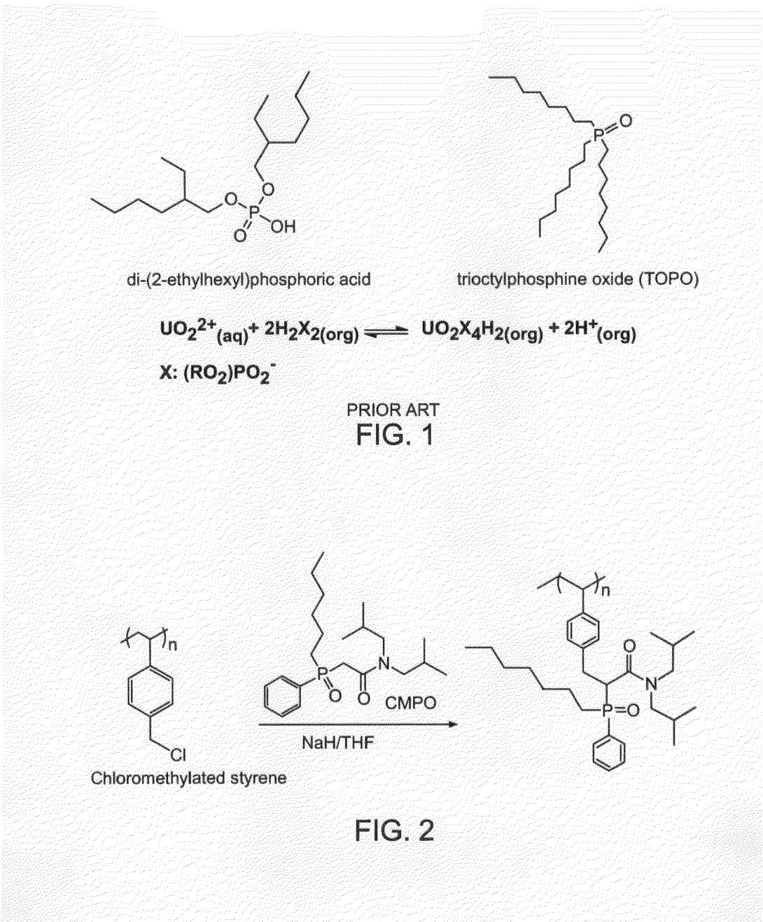

### DESCRIPTION OF THE PREFERRED EMBODIMENT

The present invention is a liquid-solid (heterogeneous) contacting system based on magnetic separation (MS) wherein uranium is extracted from aqueous acid solutions such as phosphoric acid solutions by paramagnetic and/or ferromagnetic solid material. The term “magnetic separation” as used herein refers to a process that uses a magnetic solid and an external magnetic field to separate materials or compounds. Examples of magnetic separation include magnetocollection, magnetoflocculation, and magnetoanisoptric sorting. Magnetocollection involves the application of a magnetic field gradient that causes magnetic material to move toward a region of higher field strength, thereby allowing the magnetic material to be separated from a non-magnetic medium. Magnetoflocculation is a process wherein a magnetic field causes magnetic particles to form aggregates that then settle under gravity, and magneto-anisotropic sorting, in which a magnetic field is used to orient an array of magnetic particles that allows separation of molecules based on their shape and size. High-gradient magnetic separation (HGMS) system consists of a column packed with a bed of magnetically susceptible wires that is placed inside of an electromagnet or permanent magnet. When a magnetic field is applied across the column, the wires dehomogenize the magnetic field in the column producing large field gradients around the wires that attract magnetic particles to the surfaces of the wires and trap them there.

The material comprises composite magnetic particulate materials having a core and a shell. The core is preferably composed of para- and/or ferromagnetic materials such as chromium dioxide, cobalt, amine-stabilized cobalt, magnetite and the like. The para- or ferromagentic material is preferentially stable (maintains magnetic properties), in a strongly acidic milieu. The outer shell of a magnetic particulate protects the core, amplifies the uranium extraction properties, and insulates the core from environmental effects. It can also provide a surface coating to link the particles to molecules such as polymers. Organic ligands such as uranium- and uranyl ion-complexing agents can be coupled to the shell around the magnetic material.

The solid extractant is removed from acidic solutions by magnetocollection and/or high-gradient magnetic separation. It is preferable that the solid extractant be chemically stable in highly acidic solutions. The process according to a preferred embodiment of the invention for uranium extraction includes the following steps. Phosphoric acid (at 25-30% P₂O₅) is decolorized and clarified to remove solids. The clarified acid is contacted with a solid state extractant suspension in a continuous contacting system. Uranium or the metals are transferred from the phosphoric acid to the extractant suspension. The lean phosphoric acid is then returned to the phosphoric acid plant, for example. No solvent treatment is required. Uranium adsorbed by the extractant particles is removed by a magnet and then stripped by magnetic separation using a low volume stripping solution. The electromagnet is turned off or the column is removed from a permanent magnet and the extractant particles are returned to the extraction cycling. The uranium obtained is in the alkali form. The alkali strip solution is then treated to neutralize the alkali and produce an acidic uranium solution. The acid uranium solution is reacted with hydrogen peroxide to precipitate a uranyl peroxide salt (UO₂), which is then thickened, washed, dried and calcined to produce U₃O₈ yellowcake.

The invention is illustrated by the following examples.

### EXAMPLE 1

### Core-Shell Particle Synthesis

All chemicals were obtained from Sigma-Aldrich Chemical Co. and were of highest purity available. Magtrieve™ magnetic particles (chromium dioxide, CrO₂ distributed by Sigma-Aldrich; supplier, DuPont Product® Reg. trademark of E.I. du Pont de Nemours & Co., Inc.) (0.45 g) were added to a mixture of oleic acid (0.2 mL) and hexadecane (0.4 mL), and sonicated for 5 min. The oleic acid-coated chromium dioxide, chloromethylstyrene (6 mL) and divinylbenzene (0.2 mL) were placed in a 250 ml three-necked round-bottom flask equipped with mechanical stirrer, condenser and nitrogen inlet. The flask was purged with nitrogen before reagents were added. All manipulations and the reaction were carried out under nitrogen flow. The mixture was sonicated for 30 s to obtain homogenous dispersion. To the resultant dispersion a solution of free-radical initiator 2,2′-azobis(2-methylpropionamidine)dihydrochloride (0.2 g) in deionized water (100 mL) was added and the mixture was sonicated for 13 min while stirring. Then the reaction vessel was placed in an oil bath and the reaction was carried out at 70° C. with stirring for 10 h. The resultant gray nanoparticles were separated from the reaction mixture using a strong permanent magnet, and then washed with water, ethanol and acetone. Particles were separated by centrifugation at 9000 rpm for 2 min after each wash step. The resulting dry magnetic particles weighed 4.23 g total. The particles placed in 6M aqueous phosphoric acid solution showed no signs of degradation after 3 days. In contrast, magnetite (Fe₂O₄) particles totally dissolved after 1 day and lost magnetization properties.

### EXAMPLE 2

### Grafting of Core-Shell Particles With Selective Extractant (FIG. 2)

n-Octyl(phenyl)-N,N-diisobutylcarbamoylmethylphosphine (3.06 g) was dissolved in 39 mL of tetrahydrofuran in a 100-mL two-necked round bottom flask equipped with a mechanical stirrer and nitrogen inlet. Magnetic latex particles from Example 1 (2.0) g were added to this solution and dispersed with stirring and sonication. Sodium hydride (0.18 g) was added to the dispersion and the reaction was allowed to proceed for 1 hr, with rapid stirring, under nitrogen. The grafted particles were magnetically separated and washed with ether, ethanol, water, ethanol, ether and dried. Total yield of CMPO-grafted particles was 1.53 g.

### EXAMPLE 3

### Properties of the Solid Extractant

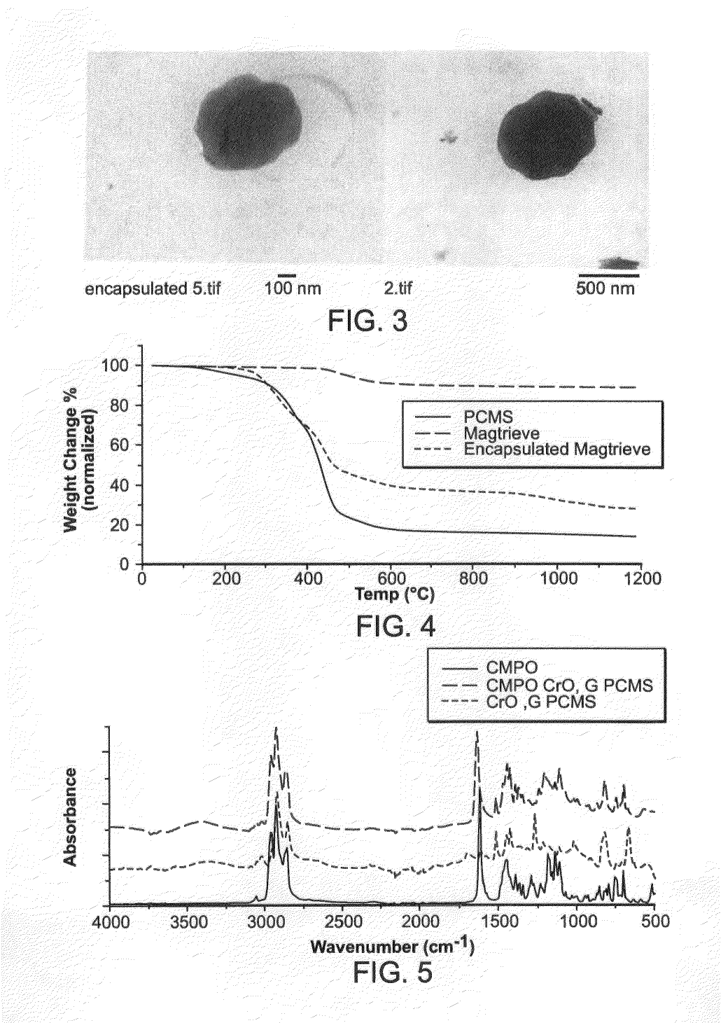

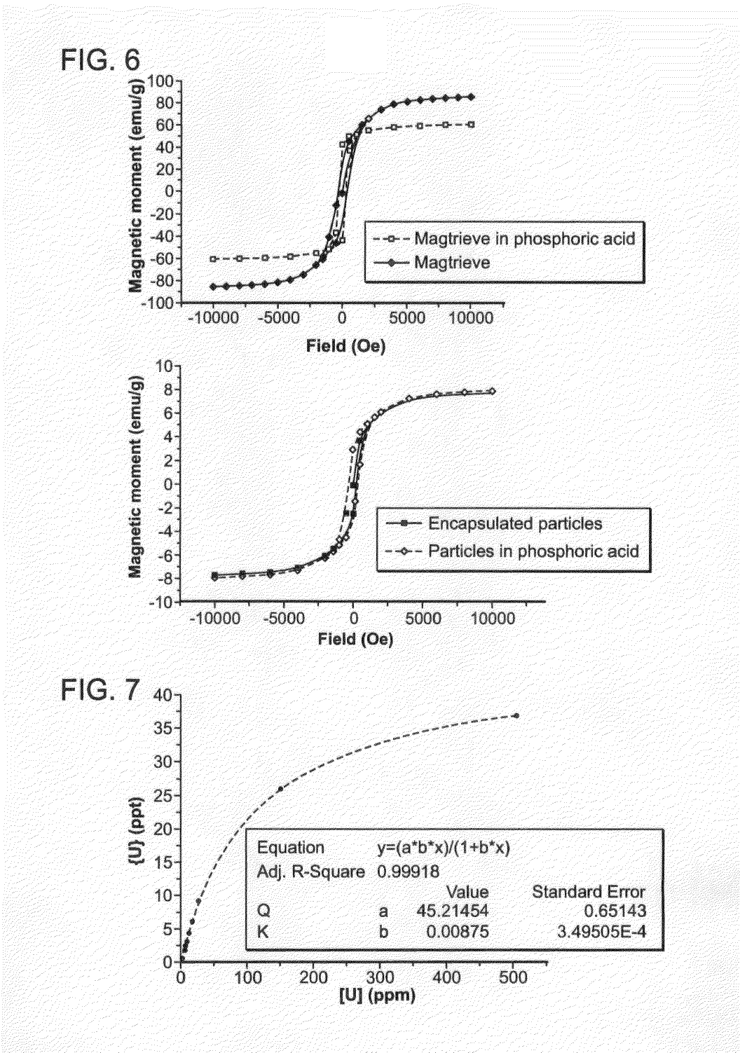

The synthesized particles were analyzed using transmission electron microscopy (FIG. 3), thermogravimetric analysis (FIG. 4), FTIR (FIG. 5), and SQUID (FIG. 6). The nanoparticles were approximately 500 nm in diameter, with needle-like chromium dioxide particles embedded inside a polymer matrix.

Attachment of CMPO did not have any effect on the morphology of the nanoparticles. TGA showed that chromium dioxide (CrO₂) decomposes to CR₂O₃ in the temperature range around 500° C., with ˜9% decrease in weight. The chloromethylated polystyrene (PCMS) decomposes above 300° C., losing about 85% of weight. PCMS-encapsulated chromium dioxide also decomposes above 300° C., but losing only 72% of weight, as expected due to presence of CrO₂ particle, which does not lose a significant fraction of its weight. From the difference in weight change the fraction of chromium dioxide in the core-shell particles was calculated and is about 9% w/w.

The attachment of CMPO to the particles was confirmed by IR and elemental analysis. The IR spectrum of the derivitized particles exhibits appearance of CMPO characteristic peaks in particular C═O stretch at 1634 cm⁻¹ and P═O stretch at 1123 cm⁻¹. Elemental analysis shows increase in C, H, N, and P content and decrease in Cr in nanoparticles derivatized with CMPO relative to underivatized ones. P was not detected in underivatized sample. 3.52 wt % of P is equivalent to 1.135 mol CMPO per 1 g of nanoparticles.

The analysis of magnetic property by SQUID shows no deterioration of magnetic properties of the magnetic nanoparticles after exposure to 6M phosphoric acid for 3 days.

### EXAMPLE 4

### Performance of the Solid Extractant in Extraction of Uranium From Acidic Solutions

A series of solutions of uranyl acetate in 6M phosphoric acid with concentration ranging from 1 to 1000 ppm were prepared. Sixty mg of core-shell particles were added to 3 ml of each solution, sonicated to disperse particles and stirred for 1 hr. The particles were magnetically separated and the remaining solution was decanted and filtered. Magnetic separation was performed using magnetocollection by means of a nickel-plated neodymium iron boron 40 MGOe permanent magnet. Concentration of U was determined spectrofluometrically, by measuring intensity of the uranyl emission peak at 493 nm of the treated solution and comparing it to fluorescence intensity of the untreated solution. From this data the mass of uranium adsorbed per mass of adsorbent ({U}) and the final concentration of uranium in solution ([U]) were calculated. Fitting a Lagmuir isotherm curve to the plot of {U} vs [U] gave maximum surface adsorption capacity of the particles equal to 45.2 ppt and the Langmuir adsorption constant, K=0.00875 ppm⁻¹ (FIG. 7).

### EXAMPLE 5

### Removal of Uranium From Solid Extractant for Reuse

In the process of uranium extraction, uranium was extracted from a 10-mL aliquot of a 0.5 mM solution of uranium in 6 M phosphoric acid with 20 mg of particles. The particles were isolated by magnetocollection and washed with water. The adsorbed uranium was stripped using 5-mL of a 1M ammonium carbonate solution.

### EXAMPLE 6

### Magnetic Separation and Reuse

High-gradient magnetic separation (HGMS) experiments were performed with a permanent magnet system as follows. The HGMS system consisted of a cylindrical polypropylene column with an internal diameter of 8 mm and a length of 20 cm that was packed with 3.6 g of type 430 fine-grade stainless steel wool (40-66 um diameter) supplied by S. G. Frantz Co., Inc. (Trenton, N.J.). For filtration, the column was placed inside of a quadrupole magnet system comprising four nickel-plated Neodymium Iron Boron 40 MGOe permanent magnets sized 18×1.8×1.8 cm each (Dura Magnetics, Inc., Sylvania, Ohio). The flux density generated inside of the packed column was ca. 0.73 Tesla.

Magnetic washing of the particles was performed by passing 10 mL of a sample that initially contained 5 mg/mL core-shell particles suspended in 6 M phosphoric acid containing 500 ppm of uranyl acetate through the column placed inside of the magnet system. The liquid was slowly passed through the column with a syringe and uranium concentration in the passing liquid was measured to be below 100 ppt. Then the column was removed from the magnet, and 20 mL of deionized water (pH adjusted to 7.0) was passed through the column to collect the washed particles. Recovery of the particles was measured to be approximately 99 wt % by weighing. The recovered and dried on air at ambient temperature particles were subjected to the uranium recovery process as described in Example 5. The process of the particles recovery and reuse was repeated in three sequential cycles.

The references and patents listed in this specification are incorporated herein by reference in their entirety.

It is recognized that modifications and variations of the invention disclosed herein will be apparent to those of ordinary skill in the art, and it is intended that all such modifications and variations be included within the scope of the appended claims.

1. Extraction method for removing metals from an aqueous acid solution, comprising:
contacting the aqueous acid solution with an extractant suspension of solid particulate material comprising a para- or ferromagnetic material core surrounded by an outer shell of a chelating polymer whereby a metal in the solution is bound to the chelated polymer, thereby removing it from the acid solution; and
magnetically separating the metal-containing solid particulate material from the solution and stripping the metal from the solid particulate material in a magnetic separation column.

2. The method of claim 1 wherein the metal is uranium.

3. The method of claim 1 wherein the metal is a rare earth metal.

4. The method of claim 3 wherein the metal is a lanthanide.

5. The method of claim 3 wherein the metal is an actinide.

6. The method of claim 1 further including using a stripping solution to produce an alkali form of the metal.

7. The method of claim 6 further including treating the stripping solution to neutralize the alkali to produce an acidic metal solution.

8. The method of claim 7 further including reacting the acidic metal solution with hydrogen peroxide to precipitate a metal peroxide salt.

9. The method of claim 8 further including thickening, washing, drying and calcining the metal peroxide salt to produce the metal.

10. The method of claim 1 wherein the core is selected from the group consisting of chromium dioxide, cobalt, and amine-stabilized cobalt.

11. The method of claim 1 wherein the outer shell of chelating polymer is CMPO.

12. The method of claim 1 wherein the outer shell of chelating polymer is TOPO.

13. Extractant particle comprising:
a para- or ferromagnetic material core surrounded by an outer shell of a chelating polymer.

14. The particle of claim 13 wherein the material core is chromium dioxide, cobalt, or amine-stabilized cobalt.

15. The particle of claim 13 wherein the shell material is CMPO or TOPO.

16. The particle of claim 13 wherein particle size is in the range of 20-200 nm.

17. The particle of claim 13, wherein the saturation magnetization is approximately 120 emu/gram.

18. The particle of claim 13 wherein the outer shell comprises a protective polymer further modified by an extractant.

19. The particle of claim 18 wherein the protective polymer is selected from the group consisting of chloromethylated polystyrene, chloromethylated polystyrene cross-linked with divinylbenzene (Merrifield resin), poly(styrene-alt-maleic anhydride), poly(methylmethacrylate), linear siloxane polymers, sesquisiloxane polymers, siloxane-silarylene polymers, silalkylene polymers, polysiloxanes, random and block copolymers, and blends of some of the above.

20. The particle of claim 18 wherein the extractant is selected from the group consisting of TOPO, CMPO, BDPPM and mixtures thereof.
